(19) United States
(12) Patent Application Publication
(10) Pub. No.: US 2026/0342828 A1
(43) Pub. Date: Oct. 29, 2026

(54) METHOD AND SYSTEM FOR INVESTIGATING ALERS IN A NETWORK FOR CYBER INSIGHTS (CI)

(71) Applicant: Honeywell International Inc., Charlotte, NC (US)

(72) Inventors: Eli (Alexey) Khitrov, Tel Aviv (IL); Tomer Angel, Rishon LeZion (IL); Rani Fischer, Rehovot (IL); Adam Engelhart, Bruchin (IL); Niv Peled, Even Yehuda (IL)

(21) Appl. No.: 19/192,383

(22) Filed: Apr. 29, 2025

(51) Int. Cl. H04L 9/40

(52) U.S. Cl. CPC H04L 63/1425; H04L 63/1416; H04L 63/1441

(57) ABSTRACT

The present invention provides a method for investigating alerts in a network for cyber insights (CI), comprising operating at least one CI sensor to mirror one or more data packets in a network traffic between a source node and a destination node; analysing, by the at least one CI sensor, one or more mirrored data packets to detect anomalous data; identifying, by the at least one CI sensor, data packet information corresponding to the one or more mirrored data packets with the anomalous data, the data packet information includes at least one of an event, a source node, a destination node, mirrored data packet command, a command type, and a communication protocol; retrieving, by the at least one CI sensor, raw packet data associated with the one or more mirrored data packets with the anomalous data; sending, by the at least one CI sensor to a central system, an alert message and the raw packet data, wherein the alert message includes the data packet information; generating, by the central system, a packet capture (Pcap) file based on the alert message and the raw packet data; and sending the alert message to at least one user device, via a user interface, for identifying intrusion detection (ID) by a user.

### TECHNICAL FIELD

Present disclosure generally relates to cyber insights in a network. More particularly, the present disclosure relates to methods and systems for generation of alerts, generating packet capture files and performing analysis of the alerts.

### BACKGROUND

The subject matter discussed in the background section should not be assumed to be prior art merely because of its mention in the background section. Similarly, a problem mentioned in the background section or associated with the subject matter of the background section should not be assumed to have been previously recognized in the prior art. The subject matter in the background section merely represents different approaches, which in and of themselves may also correspond to implementations of the claimed technology.

Enterprises such as data centers, industrial plants, and other security-sensitive environments rely on automated monitoring services to ensure operational integrity, security, and compliance with regulatory standards. Such enterprises generate and process vast amounts of data, including system logs, network traffic, sensor readings, and other telemetry data. The continuous monitoring and analysis of such data are crucial for identifying anomalous events that may indicate security breaches, system failures, or other critical operational issues.

Cyber insights provide cybersecurity solutions for operational technology (OT) networks and are configured to understand the behavior in the network. The network may include multiple assets which constantly generate data packets which are transmitted between a source node and a destination node, and the source/destination node may be following a predefined communication protocol. It is important to analyze each data packet transmitted in the network to keep a check on vulnerabilities and threats in the network and also, assist in identifying any intrusions in the network by way of Intrusion detection (ID). Typically, cyber Insights is designed as a passive network to monitor and mirror data packets relating to various events from various assets in the network using plurality insights sensors and these cyber insights sensors are connected to a central system which executes functionalities to analyse the vulnerabilities in the network and generate alerts to user. For example, the alert may be raised when the packet data includes an anomalous byte such as writing a new program on PLC, updating the configuration of the PLC, etc.

Intrusion Detection Systems (IDS) are developed to facilitate real-time monitoring of the network and system activities. IDS employs sophisticated algorithms to analyze incoming data streams, detect patterns indicative of security threats or system malfunctions, and generate alerts when predefined conditions are met. The efficiency and accuracy of the IDS plays a critical role in mitigating potential threats and ensuring the seamless operation of enterprise infrastructures.

In the network exchanging a plurality of data packets between nodes, cyber insights may be deployed in sensor mode in one or more network assets (may be referred to as CI sensors), which are configured to mirror data packets between the source and destination nodes and are exported to a central system for further analysis and user visibility. CI sensors, upon acquiring packet data, perform analysis of the packet data, and generate a packet capture (Pcap) file and save it in a database. Generally, the Pcap is a large file, and therefore, current export mechanism from the one or more CI sensors to the central system does not allow exporting this large file, as this would lead to network congestion and overloading of the network. In the absence of the Pcap files, it is difficult for the central system to perform analysis of the data packets and execute cyber insights for a user who monitors the cyber security of the network.

Hence, there exists a need for providing a solution to the above drawbacks by providing the user monitoring the cyber security with additional capabilities of receiving alerts from CI sensors, generating Pcap files and performing analysis of the packet data for detecting intrusions, vulnerability or threats.

Applicant has identified many technical challenges and difficulties associated with current solutions and through applied effort, ingenuity, and innovation, the applicant has provided a solution to the above-mentioned drawbacks.

### SUMMARY OF THE INVENTION

In general, embodiments of the present disclosure herein provide a system and a method for providing aid to the workforce in an industrial process. Other implementations will be, or will become, apparent to one with skill in the art upon examination of the following figures and detailed description. It is intended that all such additional implementations be included within this description be within the scope of the disclosure.

In an embodiment, the present disclosure provides a method for investigating alerts in a network for cyber insights (CI). The method comprises operating at least one CI sensor to mirror one or more data packets in a network traffic between a source node and a destination node and analysing, by the at least one CI sensor, one or more mirrored data packets to detect anomalous data. Further, the method comprises identifying, by the at least one CI sensor, data packet information corresponding to the one or more mirrored data packets with the anomalous data, the data packet information includes at least one of an event, a source node, a destination node, mirrored data packet command, a command type, and a communication protocol, and retrieving, by the at least one CI sensor, raw packet data associated with the one or more mirrored data packets with the anomalous data. Further, the method includes sending, by the at least one CI sensor to a central system, an alert message and the raw packet data, wherein the alert message includes the data packet information, generating, by the central system, a packet capture (Pcap) file based on the alert message and the raw packet data, and sending the alert message to at least one user device, via a user interface, for identifying intrusion detection (ID) by a user.

In an embodiment, the raw packet data includes parameters and variables of the mirrored data packets along with bytes for analysis by user, for identifying the bytes which triggered the alert message.

In a further embodiment, the method further comprises downloading, by the user device, the packet capture (Pcap) file, and saving the downloaded packet capture (Pcap) file on a local server.

In yet another embodiment, the method comprises executing the Pcap file on the local server to perform analysis of specific bytes in the mirrored data packet.

In an embodiment, the method comprises creating, by the central system, a packet dissection object for each of the alert message corresponding to one or more of the mirrored data packets with the anomalous data. The packet dissection object includes at least one of command description, command type, communication protocol, time of event, the source node and the destination node.

In yet another embodiment, the method comprises creating a link between the packet dissection object and the mirrored data packets with the anomalous data which triggered the alert message.

In another embodiment, the method comprises retrieving, by the at least CI sensor, one or more additional data packets associated with the network traffic between the source node and the destination node surrounding the mirrored data packet with the anomalous data, and creating, by the central system, one or more packet dissection objects associated with the additional data packets.

In yet another embodiment, the method comprises filtering, by the user, the one or more packet dissection objects associated with the additional data packets, based on the user selection.

In a further embodiment, the method comprises analysing the one or more packet dissection objects associated with the additional data packets, surrounding the packet dissection object associated with the mirrored data packet with the anomalous data.

According to an embodiment, a system for investigating alerts in a network for cyber insights (CI) is provided. The system comprises a central system executing cyber insights (CI), at least one cyber insight sensors (CI) sensors coupled to the central system in a network. The at least one CI sensors having one or more processors with a memory and is configured to mirror one or more data packets in a network traffic between a source node and a destination node, analyse one or more mirrored data packets to detect anomalous data, identify data packet information corresponding to the one or more mirrored data packets with the anomalous data, the data packet information includes at least one of an event, a source node, a destination node, mirrored data packet command, a command type, and a communication protocol, retrieve raw packet data associated with the one or more mirrored data packets with the anomalous data, send an alert message and the raw packet data, wherein the alert message includes the data packet information. Further, the central system is configured to generate a packet capture (Pcap) file based on the alert message and the raw packet data, and send the alert message to at least one user device, via a user interface, for identifying intrusion detection (ID) by a user.

In an embodiment, the at least user device is configured to download the packet capture (Pcap) file, and save the Pcap file on a local server.

In yet another embodiment, the at least user device is configured to execute the

Pcap file on the local server to perform analysis of specific bytes in the mirrored data packet.

In yet another embodiment, the central system is configured to create a packet dissection object for the alert message corresponding to each of the mirrored data packets with the anomalous data. The packet dissection object comprises at least one of command description, command type, communication protocol, time of event, the source node, and the destination node.

In an embodiment, the central system is configured to create a link between the packet dissection object and the mirrored data packet with the anomalous data which triggered the alert message.

In yet another embodiment, the at least one CI sensor is configured to retrieve one or more additional data packets associated with the network traffic between the source node and the destination node surrounding the data packet with the anomalous data and send the one or more additional data packets to the central system.

In another embodiment, the central system is configured to create one or more packet dissection objects associated with the additional data packets.

In yet another embodiment, the user device is configured to perform analysis of the one or more packet dissection objects associated with the additional data packets, surrounding the packet dissection object associated with the mirrored data packet with the anomalous data.

According to an embodiment, the present disclosure provides a non-transitory computer-readable storage medium storing program instructions for investigating alerts in a network for cyber insights (CI), the instructions, when executed by at least one CI sensor and a central system, perform the steps of: mirroring one or more data packets in a network traffic between a source node and a destination node, analysing one or more mirrored data packets to detect anomalous data, identifying data packet information corresponding to the one or more mirrored data packets with the anomalous data, the information includes at least one of an event, a source node, a destination node, mirrored data packet command, a command type, and a communication protocol, retrieving raw packet data associated with the one or more mirrored data packets with the anomalous data, sending an alert message and the raw packet data, wherein the alert message includes the data packet information, generating a packet capture (Pcap) file based on the alert message and the raw packet data, and sending the alert message to at least one user device, via a user interface, for identifying intrusion detection (ID).

The above summary is provided merely for the purpose of summarizing some example embodiments to provide a basic understanding of some aspects of the present disclosure. Accordingly, it will be appreciated that the above-described embodiments are merely examples and should not be construed to narrow the scope or spirit of the present disclosure in any way. It will be appreciated that the scope of the present disclosure encompasses many potential embodiments in addition to those here summarized, some of which will be further described below. Other features, aspects, and advantages of the subject will become apparent from the description, the drawings, and the claims.

### BRIEF DESCRIPTION OF THE DRAWINGS

The accompanying drawings constitute a part of the description and are used to provide further understanding of the present disclosure. Such accompanying drawings illustrate the embodiments of the present disclosure which are used to describe the principles of the present disclosure.

FIG. 1 illustrates a general architecture of a network for implementing cyber insights, in accordance with an embodiment of the present disclosure;

FIG. 2 illustrates a block diagram illustrating one or more CI sensors connected to a central system, in accordance with an embodiment of the present disclosure;

FIG. 3 illustrates an embodiment of the CI sensor, in accordance with an embodiment of the present disclosure;

FIG. 4 illustrates an embodiment of the Central system, in accordance with an embodiment of the present disclosure;

FIG. 5 illustrates an exemplary user interface illustrating an alert generated by the one or more CI sensors for the central system, in accordance with an embodiment of the present disclosure;

FIG. 6 illustrates an exemplary user interface illustrating data traffic associated with the alert for analysis by user, in accordance with an embodiment of the present disclosure;

FIG. 7 illustrates an exemplary user interface illustrating packet dissection object in respect of the alert for analysis by the user, in accordance with an embodiment of the present disclosure;

FIG. 8 illustrates an exemplary user interface illustrating network traffic surrounding the alert for analysis by the user, in accordance with an embodiment of the present disclosure;

FIG. 9 illustrates a flowchart for investigation alert in the network, according to an embodiment of the present disclosure; and

FIG. 10 illustrates general architecture of the system for implementation, in accordance with an embodiment of the present invention.

The embodiments are illustrated by way of example and not by way of limitation in the figures of the accompanying drawings in which references indicate similar elements. It should be noted that references to “an” or “one” embodiment in this disclosure are not necessarily to the same embodiment, and they mean at least one in the drawings.

### DETAILED DESCRIPTION OF THE INVENTION

Some embodiments of the present disclosure now will be described more fully hereinafter with reference to the accompanying drawings, in which some, but not all, embodiments of the disclosure are shown. Indeed, embodiments of the disclosure may be embodied in many different forms and should not be construed as limited to the embodiments set forth herein, rather, these embodiments are provided so that this disclosure will satisfy applicable legal requirements. Like numbers refer to like elements throughout.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in one embodiment,” “according to one embodiment,” “in some embodiments,” and the like generally mean that the particular feature, structure, or characteristic following the phrase may be included in at least one embodiment of the present disclosure, and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations.

The present disclosure relates to systems and methods for investigating alerts in the network for implementing Cyber Insights (CI). As enterprises generate large amounts of data traffic from various connected devices, it is essential to analyze the data traffic for anomalies that may indicate security threats or system issues. Cyber Insights are implemented in sensor mode on devices which intercept or mirrors the data packets exchanged within the network and use the data packets for generating insights on cybersecurity. The devices which execute cyber insights in sensor mode may be referred to as Cyber insights (CI) sensors. The CI sensors may generate a packet capture (Pcap) file which contains raw network traffic captured during the transmission of data over a network. The Pcap file records the packets of data sent between devices on the network and includes detailed information about the contents of each packet, such as the source and destination address, communication protocols used, payload data, and timing information. In general, the Pcap files are often saved in formats like PCAP (Packet Capture) or PcapNG (Pcap Next Generation) and are analyzed using network analysis tools. These files are useful for monitoring network performance and conducting security analysis to detect potential threats or malicious activity.

As there are multiple CI sensors implemented in the network for mirroring the data packets between various nodes, each CI sensor may generate a Pcap file and save the same in a database. A central system may be connected to each of the CI sensors in the network and may utilize information received from each CI sensor for generating insights on cyber security of the network. One of the key information required for generating insights is the Pcap which includes data packets containing raw network traffic captured during the transmission of data over the network. The current export mechanism does not allow each CI sensor to send the respective Pcap file to the central system, as the Pcap is generally large in size and the current export mechanism may not allow transporting such a large file over the network which may lead to network congestion.

The disclosed systems and methods provide a mechanism wherein the central system is equipped to generate the Pcap file based on information provided by each of the CI sensors, generate packet dissection object, and also, provide an analysis of traffic surrounding the data packet, which triggered an alert for accessing intrusion or vulnerability.

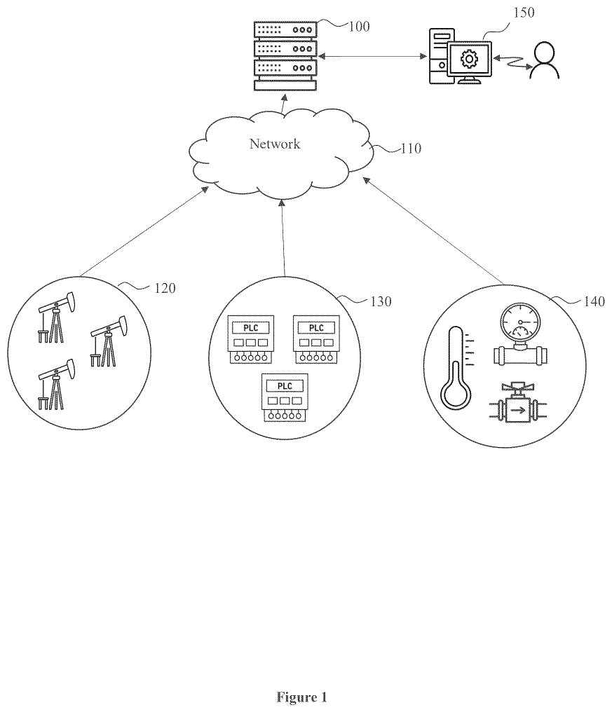

FIG. 1 illustrates an architecture of a system 100 for alert management and investigation. Enterprises including, but not limited to, a workstation 120, an IT infrastructure 130, and an industrial plant 140 may provide a plurality of information to the system 100 for alert investigation and management. Such enterprises generate and process vast amounts of data, including system logs, network traffic, sensor readings, and other telemetry data. Therefore, such enterprises rely on automated monitoring services to ensure operational integrity, security, and compliance with regulatory standards. The continuous monitoring and analysis of such data are crucial for identifying anomalous events that may indicate security breaches, system failures, or other critical operational issues. The system 100 provides automated monitoring services to the workstation 120, the IT infrastructure 130, and the industrial plant 140. In an embodiment, the system 100 may be an intrusion detection system which implements cyber insights for analyzing and monitoring cyber security of the network.

The system 100 may operate by mirroring data traffic received from such enterprises, via a communication network 110, allowing for real-time monitoring and analysis without directly integrating with networks inside the enterprises. The communication network 110 may utilize network components to establish connection among the system 100, and the workstation 120, the IT infrastructure 130, and the industrial plant 140. The network components may include, hubs, switches, routers, bridges, and repeaters. The routers may be of different types such as Provide Edge (PE) routers, Customer Edge (CE) routers, and intermediate routers. Further, the data traffic is the flow of digital information transmitted between one or more devices, systems, and networks within an enterprise. The data traffic may include but is not limited to, network packets, system logs, and sensor data that provide insights into operational state of the enterprise.

The communication network 110 may be a wired and/or a wireless network. The communication network 110 may be implemented using communication techniques such as Visible Light Communication (VLC), Worldwide Interoperability for Microwave Access (WiMAX), Long Term Evolution (LTE), Wireless Local Area Network (WLAN), Infrared (IR) communication, Public Switched Telephone Network (PSTN), Radio waves, and other communication techniques known in the art.

By mirroring the data traffic, the system 100 can analyze patterns, identify anomalies, and generate alerts without directly interacting with or modifying devices, systems, and networks of the workstation 120, the IT infrastructure 130, and the industrial plant 140. By employing a mirroring approach, the system 100 ensures that ongoing operations within the enterprises remain unaffected. Such an approach eliminates the risk of increased system overhead, performance degradation, or security vulnerabilities that might arise from direct integration. The system 100 continuously monitors mirrored data for anomalies, identifying potential security threats, system failures, or other critical operational events. Upon identifying an anomalous event, the system 100 is configured to generate an alert based on predefined detection criteria.

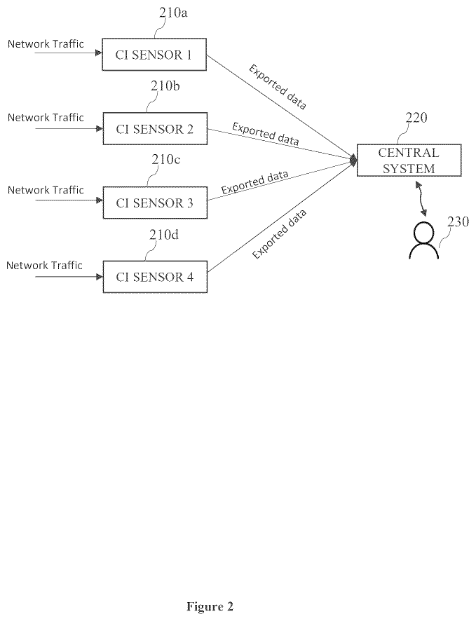

The system 100, in one embodiment, is configured to mirror data packets and generate a Pcap file which contains raw network traffic captured during the transmission of data over a network. The Pcap file records the packets of data sent between devices on a network and includes detailed information about the contents of each packet, such as the source and destination address, protocols used, payload data, and timing information. Further, the system 100 is configured to generate an alert upon detection of a predetermined pattern of one or more data bytes in the data packets which may indicate one or more vulnerabilities or threats. In an example, the vulnerabilities may be identified based on a data packet which includes bytes indicating a configuration of program logic controller (PLC) of a destination device, re-setting of device operations, etc. A more detailed embodiment of the system 100 will be explained in reference to FIG. 2.

FIG. 2 provides a block diagram illustrating one or more CI sensors 210a . . . 210d connected to a central system 220, in accordance with an embodiment of the present disclosure. As explained in reference to FIG. 1, the system may comprise one or more CI sensors 210a . . . 210d which are network components implement cyber insights in the sensor mode. One or more CI sensors 210a . . . 210d are configured to mirror the data traffic between each of the source node and the destination node and capture the data packet to create Pcap file. To identify the anomalous event, one or more CI sensors 210a . . . 210d may utilize data processing techniques, including but not limited to, real-time anomaly detection algorithms, machine learning-based threat assessments, and pattern recognition models. Further, one or more CI sensors 210a . . . 210d generate one or more alert message including alert parameters, alert type, severity levels, the source node, the destination mode, and communication protocol. Further, one or more CI sensors may generate the Pcap file and save the Pcap file in the database.

As illustrated, the one or more CI sensors 210a . . . 210d are coupled to a central system 220. The central system 220 receives information from the one or more CI sensors 210a . . . 210d for generating insights on cybersecurity of the network. Upon detection of an anomalous event/anomaly, the one or more CI sensors 210a . . . 210d are configured to generate an alert and send it to the central system 220. The central system 220 is accessible by a user 230 via a user device. In an exemplary embodiment, the user device may be a handheld device or a computer. The user device(s) may refer to, for example, one or more computers, computing entities, desktop computers, mobile phones, tablets, phablets, notebooks, laptops, distributed systems, servers, or the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein.

The central system 220 is configured to implement cyber insights for analyzing cybersecurity. The central system 220 typically utilizes packet capture (Pcap) files and by analyzing raw packet data, the central system 220 may identify anomalies, unauthorized access, triggering events such as reconfiguration prompts, malware communications. The central system 220 also provides a visualization tool which is monitored by the user 230 centrally and this centralized approach allows the user to correlate data across multiple sources. Further, the visualization tools may provide actionable insights, enabling proactive threat mitigation and robust cybersecurity defenses.

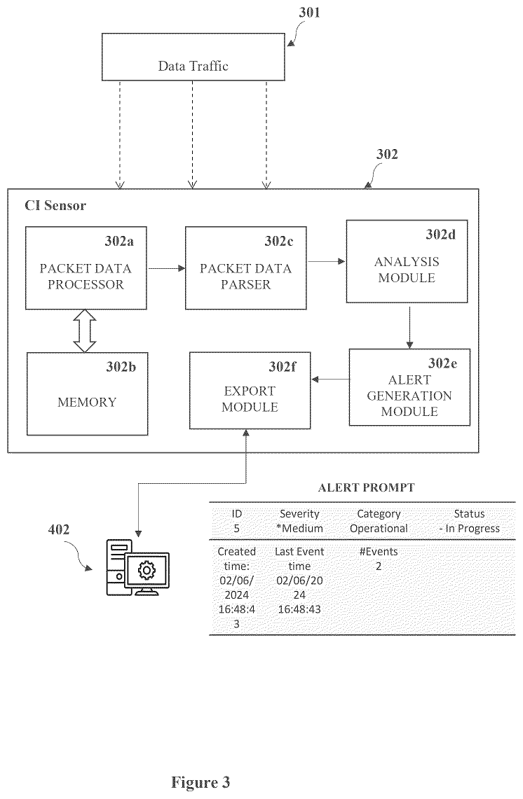

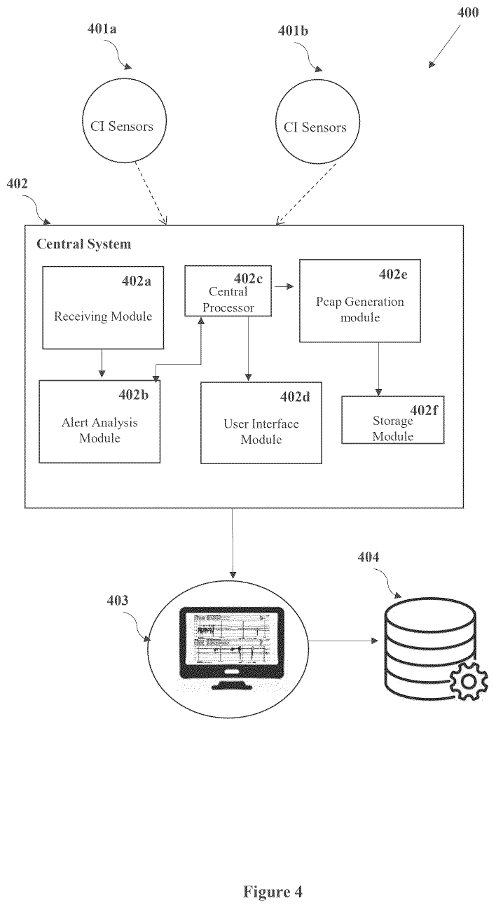

However, the current export mechanism from one or more CI sensors to the central system does not allow each CI sensor to send the respective Pcap file to the central system 220, as the Pcap is generally large in size and the current export mechanism may not allow transporting such a large file over the network and may lead to network congestion. The present disclosure provides one or more CI sensors 210a . . . 210d, which are configured to generate the alert message and the Central system is configured to generate the Pcap files based on the generated Alert message. More detailed embodiments of the one or more CI sensors 210a . . . 210d and the central system 220 are explained below in reference to FIG. 3 and FIG. 4.

FIG. 3 illustrates an embodiment of the CI sensor 302, in accordance with an embodiment of the present disclosure. One or more network components operating as Cyber Insight (CI) sensor 302 is configured to mirror data traffic 301 and comprises a packet data processor 302a and a memory 302b coupled to the packet data processor 302a. Further, the CI sensor 302 comprises a packet data parser 302c, an analysis module 302d, an alert generation module 302e, and an export module 302f.

The packet data processor 302a is configured to receive a mirror copy of one or more data packets between the source node and the destination node and processes the data packet. In one embodiment, the packet data is processed to identify one or more parameters of the data packets. The parameters may include, but are not limited to, the source node, the destination node, a type of data packet, and communication protocol. Each data packet contains a header and payload, where the header includes metadata such as source and destination IP addresses, protocol types, and sequence numbers. The Packet data processor 302a processes these packets in real time to detect malicious activities. In an embodiment, the packet data processor 302a is configured to leverage machine learning and signature-based analysis to identify anomalies, malware, or cyber threats, ensuring robust network security and incident response.

In an embodiment, the packet data processor 302a captures raw packet data from the network traffic between the source and destination mode and uses the raw packet data for identifying anomalies. The raw packet data may include parameters and variables of the mirrored data packets along with bytes for analysis by user based on which it may be determined whether the alert needs to be triggered.

The packet data processor 302a is configured to create a packet capture (Pcap) file and store the same in the memory 302b. The Pcap file records the data packets sent between the source and the destination nodes on the network and includes parameters about the contents of each packet, such as the source and destination address, protocols used, payload data, and timing information. In general, the Pcap file often saved in formats like PCAP (Packet Capture) and are analyzed using network analysis tools.

The memory 302b is coupled to the packet data processor 302a and the memory 302b is configured to save the parameters associated with the received packet data. In a further embodiment, the memory 302b comprises predetermined parameters associated with the detection of anomalies, malware, or cyber threats and supports the packet data processor 302a for processing the data packet. The memory 302b is configured to store parameters that define conditions for triggering alerts, severity levels associated with different types of anomalies, and corresponding actions to be taken upon detecting an anomalous event. The parameters may include, but are not limited to, threshold values for anomaly detection, time-based constraints for alert activation, escalation protocols, notification preferences, and response actions such as logging, automated remediation, or user notifications. Further, the parameters may be modified. Modifications in the parameters may be made due to various factors, including changes in threshold values for triggering alerts, alterations in the network infrastructure, addition or removal of system components, or the refinement of security policies.

The packet data parser 302c is coupled to the packet data processor 302a and is configured to parse the packet data information. The packet data parser 302c is configured to process and parse meaningful information from packet capture (PCAP) files or network streams. The packet data parser 302c is configured to systematically dissect packet structures, separating headers, payloads, and metadata to interpret protocols such as TCP, UDP, and ICMP. In an embodiment, the packet data parser 302c extracts key attributes like source and destination IP addresses, port numbers, timestamps, packet lengths, and protocol types, which are essential for cybersecurity analysis.

The analysis module 302d is coupled to the packet data parser 302c, and is configured to execute one or more analyses to detect at least one vulnerability or threat. In an embodiment, the analysis module 302d is configured to implement deep packet inspection (DPI) techniques to decode application-layer data, detect anomalies, and identify potential security threats. In one embodiment, the analysis module 302d executes deep packet inspection (DPI) to examine data packets exchanged between the source nodes and destination nodes, and identify vulnerabilities or potential threats in real time. In an embodiment, packet headers and payloads are analyzed and malicious patterns are detected, for example, unusual traffic behavior, or protocol anomalies that may indicate cyber threats. Based on the analysis of the packet data, the analysis module 302d may classify the vulnerabilities or threats in at least one of the categories including low, medium, or severe. Classifying cyber threats as low, medium, or severe is important for effective threat management and this classification may be based on specific data bytes within packet data, such as payload size, unusual protocol behavior, encrypted command-and-control (C2) communications, or known malicious signatures. For example, low-risk threats may include benign anomalies like misconfigured packets, while medium threats could involve data bytes which indicates stop commands to a programmable login controller (PLC), writing a new program to the PLC, or changing a configuration value on the PLC. Severe threats may include ransomware payloads, or DDoS attack patterns.

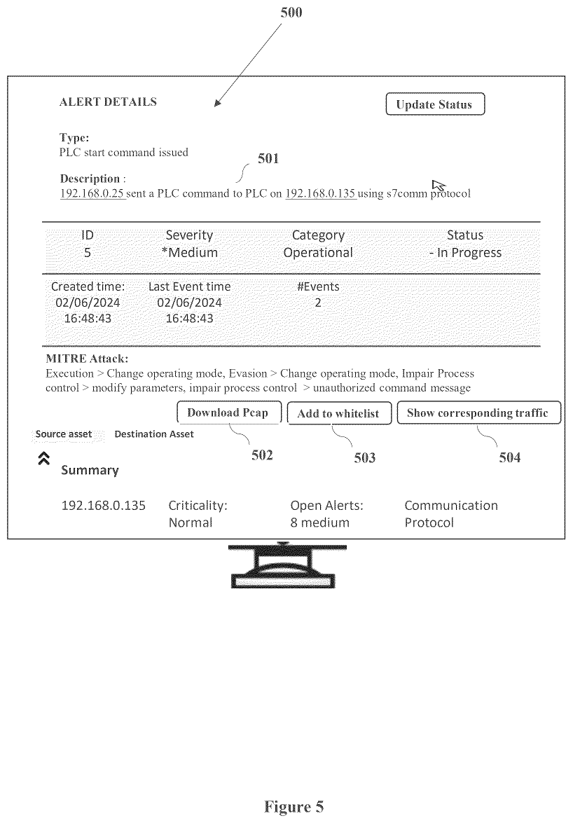

The analysis module 302d is further coupled to the alert generation module 302e wherein the alert generation module 302e is configured to generate at least one alert based on a triggering event. When a suspicious packet is detected, the alert generation module 302e triggers the alert that includes key details such as the type of command executed (e.g., unauthorized access attempt, reconfiguration command, stop command, or malware execution), along with information about the source node (IP address, device details) and the destination node (target system, port number). In an embodiment, the alert also specifies the communication protocol used, such as TCP, UDP, or HTTP. Additionally, the alert contains information on the severity level of the threat which is categorized as low, medium, or severe, and is assigned based on predefined threat intelligence rules and anomaly detection algorithms. An exemplary embodiment of an alert message is illustrated with reference to FIG. 5.

The alert generation module 302e is coupled to the export module 302f, wherein the export module 302f is configured to export the generated alert to a central system 402. As discussed above, the current export mechanism does not allow each CI sensor to send the respective Pcap file to the central system 402, as the Pcap is generally large in size and the current export mechanism may not allow transporting such a large file over the network and may lead to network congestion. Therefore, the CI sensors are configured to generate an Alert message and send the Alert message along with raw packet data to the Central system 402 to generate Pcap files based on the generated Alert message and raw packet data. More detailed embodiments of the central system 402 are explained below in reference to FIG. 4.

FIG. 4 illustrates the central system 402, in accordance with an embodiment of the present disclosure. In an embodiment, the central system 402 comprises a receiving module 402a and an Alert analysis module 402b coupled to the receiving module 402a. In an embodiment, the receiving module 402a is configured to receive the alert message from the one or more CI sensors along with raw packet data which includes the actual network packets associated with the detected threat.

The Alert analysis module 402b coupled to the receiving module 402a receives the alert and performs one or more analysis on the alert Message. As discussed above, the alert message received from the one or more CI sensors include details such as the type of command executed (e.g., unauthorized access attempt, reconfiguration command, stop command, or malware execution), along with information about the source node (IP address, device details) and the destination node (target system, port number). In an embodiment, the alert also specifies the communication protocol used, such as TCP, UDP, or HTTP. Additionally, the alert contains information on the severity level of the threat which is categorized as low, medium, or severe, and is assigned based on predefined threat intelligence rules and anomaly detection algorithms.

The Alert analysis module 402b analyzes each field of the alert message to derive meaningful insights from the alert and provides the parameters identified from the alert message to a central processor 402c which processes the parameters to identify if the user monitoring the cybersecurity needs to be alerted. In an embodiment, the alert messages contain various data fields, including timestamps, source and destination IP addresses, threat severity levels, attack types, and additional metadata. The alert analysis module 402b parses each alert message, and extracts key parameters for example threat type, severity level, affected assets, source of the threat, timestamps, and correlation with past events.

In an embodiment, the central processor 402c is configured to apply analytical techniques on the parameters extracted from the alert message. In an exemplary embodiment, the analytical technique may comprise rule based analysis with predefined security rules to determine if an alert should be raised. In another exemplary embodiment, a machine learning model may be implemented to identify specific patterns to identify vulnerability or threat based on raw data of the data packet.

In the event, the central processor 402c determines that one or more parameters is critical in nature and an alert needs to be raised based on predefined threshold values, the central processor 402c triggers a message to a user via a user interface 403 through a user interface module 402d. Further, the alert message and the trigger message may be stored in a storage module 402f.

In an embodiment, the central system 402 comprises a Pcap generation module 402e which is configured to generate a Pcap file based on the alert message and the raw packet data sent by the one or more CI sensors. The Pcap generation module 402e plays a critical role in capturing and storing network traffic data for analysis. In an embodiment, the Pcap generation module 402e is configured to generate PCAP files based on the alert messages and the raw packet data received from the one or more CI sensors deployed across the network. The generated PCAP files contain detailed packet-level information that helps the user to investigate potential threats and incidents.

In an embodiment, the Pcap generation module 402e processes both the alert message and the raw packet data to extracts key information such as packet headers, payloads, and metadata. In an embodiment, the Pcap generation module 402e determines which packets are relevant to the security event and structures them into a PCAP file format. The Pcap generation module 402e organizes the raw packet data into a standard PCAP format, ensuring compatibility with packet analysis tools for example, Wireshark, Zeek, Suricata, and other analysis tools. Further, the generated PCAP file is timestamped and indexed for easy retrieval during investigation.

The Pcap generation module 402e upon generating the Pcap file, sends the file to the storage module 402f for future analysis. The Pcap Generation Module 402e is a critical component of the central system, enabling it to capture, store, and analyze network traffic related to security incidents. By generating the Pcap files based on alert messages and raw packet data from one or more CI sensors, it enhances cybersecurity monitoring, investigation, and response capabilities.

In an embodiment, the user interface 403 is also coupled to a local server 404. In an embodiment, the user may download the Pcap generated by the Central system 402 and save a copy in the local server 404 for future retrieval and offline analysis. In an embodiment, the user may execute the Pcap files on the local server 404 to perform one or more analysis associated with cyber security and to analyze cyber insights. In an embodiment, the user may analyze specific bytes of the mirrored packet data from the network which triggered the alert message from the one or more CI sensors.

In an embodiment, the alert analysis module 402b is further configured to generate one or more packet dissection objects. The packet dissection object enables the user to break down network traffic at a granular level to investigate potential threats and vulnerabilities. The packet dissection object deconstructs network data packets which triggered the alert into their fundamental components, including headers, payloads, and metadata, to assess the nature and intent of the communication. The packet dissection object organizes these attributes in a way that the user can quickly identify malicious patterns in the data packet. In an embodiment, the packet dissection object may provide information such as protocol details, source, and destination IP addresses, communication protocol, timestamp of the event, command description, and command type. In a further embodiment, the alert analysis module 402b is configured to link the generated packet dissection object with the mirrored data packets with the anomalous data which triggered the alert message.

In a further embodiment, the alert analysis module 402b is further configured to generate network traffic surrounding the Alert for analysis by the user, in accordance with an embodiment of the present disclosure. In an embodiment, the one or more CI sensors may retrieve additional data packets associated with the network traffic between the source node and the destination node surrounding the data packet with anomalous data. The surrounding network traffic may be sent to the central system 402, which may create packet dissection object for each of the additional data packets associated with the surrounding traffic.

FIG. 5 illustrates an exemplary user interface illustrating an alert message 500 generated by the one or more CI sensors for the central system, in accordance with an embodiment of the present disclosure. In an embodiment, the alert message 500 comprises one or more fields relating to the data packet which includes anomalous data indicating a vulnerability or a cyber threat. For example, the Alert message 500 generated by the one or more CI sensors is displayed on the user interface and may include alert type, the source node, the destination node, severity of threat, asset IDs, network traffic visualization, options for downloading packet capture (PCAP) files, and a summary of the incident.

Each alert message 500 displayed on the user interface may follow a structured format to ensure that the user can quickly assess and respond to incidents. In an embodiment, the alert message 500 includes the alert type which defines the nature of the security event. This helps the user to categorize and prioritize threats. For example, the alert type may include writing a new program on PLC, and updating the configuration of the PLC. In a further example, the alert type may include an indication of an unauthorized access attempt.

In a further embodiment, the alert message 500 may include a description of the alert. The description provides a detailed explanation of the alert, including its origin, impact, and potential consequences. The alert description may include detection time, the source node which is responsible for the triggering of the alert, the destination node which is the affected node, communication protocol between the source and the destination node, and the type of alert for the user reference.

In a further embodiment, the alert message 500 may include the severity level of the threat. CI sensors may assign severity levels based on predefined risk scoring mechanisms. The severity levels may include either low, medium, or critical based on the threat posed on the network assets. The alert message 500 may further comprise Asset IDs which help identifying the affected systems within the network. Each device in the network is assigned a unique identifier, allowing security teams to trace incidents back to specific machines or users.

In yet another embodiment, the user interface may provide one or more options which enable the user to perform downloading of the Pcap files generated by the central system and showing corresponding traffic. In an example, action button(s) may be provided on the user interface for quick downloading of the Pcap files on the user's system and can be stored on the local server. Also, the user is configured to download raw data packets associated with the alert message for conducting in-depth investigations by examining traffic patterns and payloads.

In a further embodiment, the user interface provides interactive buttons to show corresponding network traffic that allows the user to view real-time network traffic associated with the alert. Further, the user interface may provide a summary of the Alert which provides a high-level overview of the alert, summarizing key findings and recommended actions. In the alert message displayed on the user interface, an action button may be provided to whitelist any alert by analysing data traffic surrounding the data packet which triggered the alert.

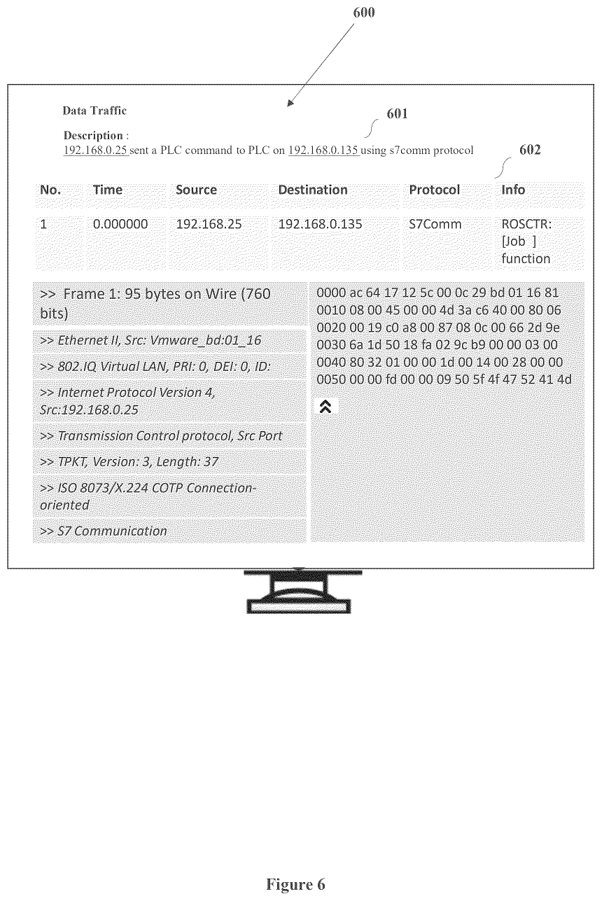

FIG. 6 illustrates an exemplary user interface illustrating data traffic associated with the alert for analysis by the user, in accordance with an embodiment of the present disclosure. The Pcap file is a standardized format used to store network traffic captured by any of packet-sniffing tools like Wireshark, and other network analysers. The Pcap file contains raw packet data, including headers and payloads of network packets transmitted over the network. Each packet in the PCAP file consists of several components for example, timestamp (indicating when the packet was captured), source and destination MAC addresses (for Ethernet frames), IP addresses, protocol information (such as TCP, UDP, or ICMP), port numbers, and the payload. This raw packet data allows the user to inspect traffic patterns, analyze potential security threats, and perform investigations.

In an embodiment, the headers may contain the Ethernet frame details, including source and destination MAC addresses which indicate unique identifiers for network devices. Further, ether type is identified which specifies the type of protocol carried in the payload (e.g., IPv4, IPv6). Further, the packet data includes network layer data which include details of IP-based communication, including the source and the destination IP addresses, protocol type indicating whether the packet carries TCP, UDP, ICMP, or another protocol. In another embodiment, the packet data may also include transport layer data and application layer data.

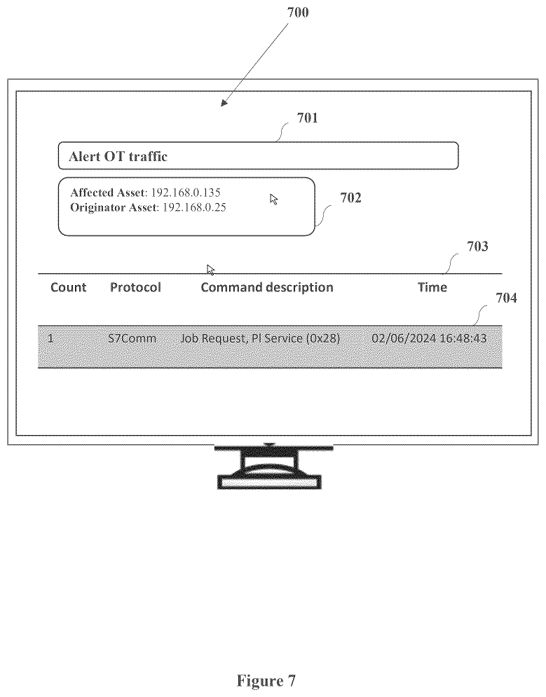

FIG. 7 illustrates an exemplary user interface illustrating packet dissection object 700 in respect of the alert for analysis by the user, in accordance with an embodiment of the present disclosure.

In an embodiment, the user interface may provide the user an option to generate the packet dissection object 700, which breaks down network traffic at a granular level to investigate potential threats and vulnerabilities. The user accessing the central system is configured to generate the packet dissection object for each data packet which triggered the alert and this process involves deconstructing network packets into their fundamental components, including headers, payloads, and metadata, to assess the nature and intent of the communication. The packet dissection object 700 organizes these attributes in a way that the user can quickly identify malicious patterns in the data packet. As illustrated, the packet dissection object may provide information 704 such as protocol details, source, and destination IP addresses 702, communication protocol, timestamp of the event.

In an embodiment, the packet dissection object 700 is associated with the packet which triggered the alert with anomalous data. For example, the protocol information in the packet dissection object may identify network protocols used in communication protocols such as TCP, UDP, ICMP, HTTP, HTTPS, DNS, FTP, SSH, and SMTP can indicate the nature of the traffic. In a further embodiment, the packet dissection object may include command description which includes job request details, type of request made. Further, the packet dissection object 700 may include exact timestamp of packet capture which is essential for investigation and, correlation with other security events.

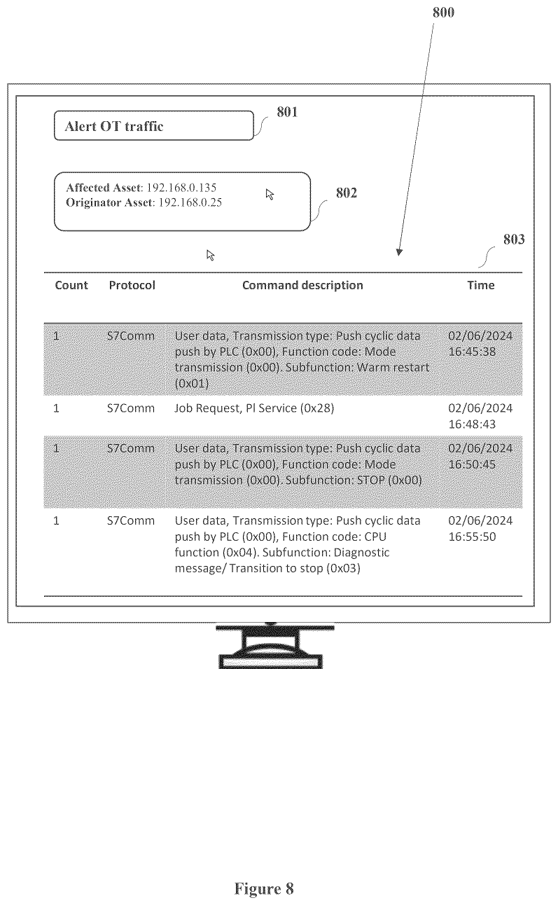

FIG. 8 illustrates an exemplary user interface illustrating network traffic surrounding the alert for analysis by the user, in accordance with an embodiment of the present disclosure.

In an embodiment, the one or more CI sensors may retrieve additional data packets associated with the network traffic between the source node and the destination node surrounding the data packet with anomalous data. The surrounding network traffic may be sent to the central system, which may generate a packet dissection object for each of the additional data packets associated with the surrounding traffic. In an embodiment, the user device may analyse the command description associated with packet dissection objects of the data packet which triggered alert and additional data packet of surrounding traffic, to analyse if the alert is a false alert and if can it be ignored or whitelisted. An action button may be provided to whitelist any alert by analysing data traffic surrounding the data packet which triggered the alert.

In an additional embodiment, the user device may filter packet dissection objects based on the user selection of one or more variables, which may include command description, command type. By analyzing the surrounding traffic, the user can identify patterns and assess whether the alert may be ignored.

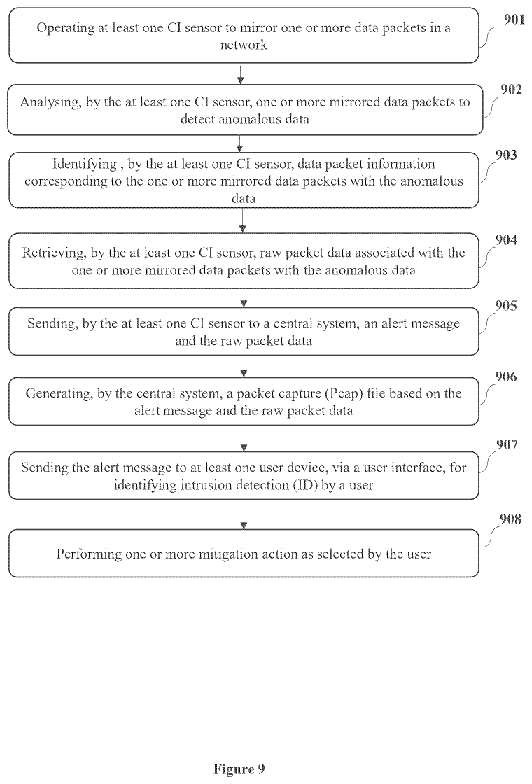

FIG. 9 provides a flowchart for investigation alerts in the network, according to an embodiment of the present disclosure. In Step 901, at least one or more CI sensors 302 are operated to mirror one or more data packets in the network traffic between the source node and the destination node.

In Step 902, the at least one or more CI sensors 302 analyses the one or more mirrored data packets to detect anomalous data. In an embodiment, to identify the anomalous event by the one or more CI sensors 302, it may utilize data processing techniques, including but not limited to, real-time anomaly detection algorithms, machine learning-based threat assessments, and pattern recognition models. In an embodiment, the packet data processor 302a processes these packets in real time to detect malicious activities, unauthorized access, or policy violations. In an embodiment, the packet data processor 302a is configured to leverage machine learning and signature-based analysis to identify anomalies, malware, or cyber threats, ensuring robust network security and incident response.

In Step 903, the at least one or more CI sensors 302 identifies data packet information corresponding to the one or more mirrored data packets with the anomalous data, the data packet information includes at least one of an event, a source node, a destination node, mirrored data packet command, a command type, and a communication protocol. In an embodiment, the packet data parser 302c is coupled to the packet data processor 302a, and is configured to parse the packet data information. A packet data parser 302c is configured to extract meaningful information from raw packet capture (PCAP) files or network streams. The packet data parser 302c is configured to systematically dissects packet structures, separating headers, payloads, and metadata to interpret protocols such as TCP, UDP, and ICMP. In an embodiment, the packet data parser 302c extracts key attributes like source and destination IP addresses, port numbers, timestamps, command type, command description, packet lengths, and protocol types, which are essential for cybersecurity analysis.

In Step 904, the at least one or more CI sensors 302 also retrieves raw packet data associated with the one or more mirrored data packets with the anomalous data to generate Pcap file. The Pcap file contains raw packet data, including headers and payloads of network packets transmitted over a network. Each packet in a PCAP file consists of several components for example, timestamp (indicating when the packet was captured), source and destination MAC addresses (for Ethernet frames), IP addresses, protocol information (such as TCP, UDP, or ICMP), port numbers, and the payload. This raw packet data allows the user to inspect traffic patterns, analyze potential security threats, and perform investigations. Further, in an embodiment, the Header may contain the Ethernet frame details, including Source and Destination MAC addresses which indicate Unique identifiers for network devices. Further EtherType is identified which specifies the type of protocol carried in the payload (e.g., IPv4, IPv6). Further, the packet data includes network layer data which include details of IP-based communication, including Source and Destination IP addresses, Protocol Type indicating whether the packet carries TCP, UDP, ICMP, or another protocol. In another embodiment, the packet data may also include transport layer data and application layer data.

In Step 905, the one or more CI sensors 302 are configured to send to the central system 402, an alert message and the raw packet data, wherein the alert message includes the data packet information. In an embodiment, the receiving module 402a of the central system 402 is configured to receive the alert message from the CI sensors 302 along with raw packet data which includes the actual network packets associated with the detected threat.

In Step 906, the central system 402 is configured to generate the packet capture (Pcap) file based on the alert message and the raw packet data. In an embodiment, the Alert analysis module 402b coupled to the receiving module 402a receives the alert and performs one or more analysis on the Alert Message. The Alert message received from the CI sensors includes details such as the type of command executed (e.g., unauthorized access attempt, reconfiguration command, stop command, or malware execution), along with information about the source node (IP address, device details) and the destination node (target system, port number). The alert also specifies the communication protocol used, such as TCP, UDP, or HTTP. Additionally, the alert contains information on the severity level of the threat which is categorized as low, medium, or severe and is assigned based on predefined threat intelligence rules and anomaly detection algorithms. In an embodiment, the central system 402 comprises the Pcap generation module 402e which is configured to generate the Pcap file based on Alert message and raw packet data sent by the CI sensors 302. In an embodiment, the Pcap generation module 402e is configured to generate PCAP files based on alert messages and raw packet data received from CI sensors deployed across the network. The generated PCAP files contain detailed packet-level information that helps the user to investigate potential threats and incidents.

In Step 907, the alert message is sent to the at least one user device, via a user interface, for identifying intrusion detection (ID) by a user. In an embodiment, the alert analysis module 402b parses each alert message, and extracts key parameters for example threat type, severity level, affected assets, source of the threat, timestamps, and correlation with past events. In an embodiment, the central processor 402c is configured to apply analytical techniques on the parameters extracted from the Alert message. In an exemplary embodiment, the analytical technique may comprise rule based analysis with predefined security rules to determine if an alert should be raised. In the event, the central processor 402c determines that one or more parameters are critical in nature and an alert needs to be triggered based on predefined threshold values, the central processor 402c triggers a message to a user interface 403 via a user interface module 402d.

In Step 908, the user may perform one or more mitigation actions based on selection. In an embodiment, the alert message may comprise one or more mitigation strategies based on the level of threat or vulnerabilities in the alert message.

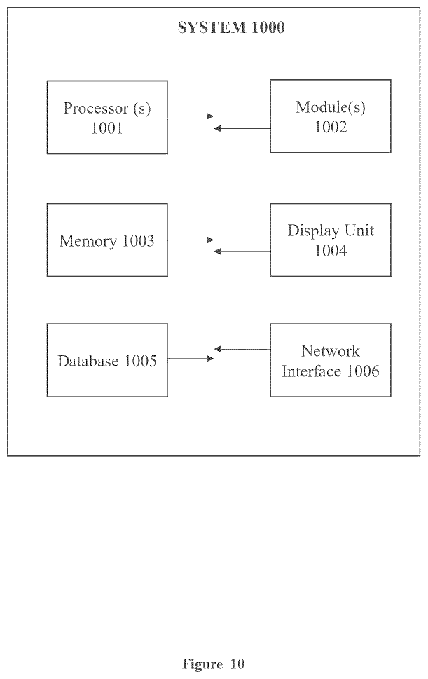

FIG. 10 illustrates a general architecture of the system 1000 for implementation, in accordance with an embodiment of the present invention.

In an example, the processor(s) 1001 may be a single processing unit or a number of units, all of which could include multiple computing units. The processor(s) 1001 may be implemented as one or more microprocessors, microcomputers, microcontrollers, digital signal processors, central processing units, logical processors, virtual processors, state machines, logic circuitries, and/or any devices that manipulate signals based on operational instructions. Among other capabilities, the processor(s) 1001 is configured to fetch and execute computer-readable instructions and data stored in a memory 1003.

The memory 1003 may include any non-transitory computer-readable medium known in the art including, for example, volatile memory, such as static random-access memory (SRAM) and dynamic random-access memory (DRAM), and/or non-volatile memory, such as read-only memory (ROM), erasable programmable ROM, flash memories, hard disks, optical disks, and magnetic tapes.

In an example, the module(s), engine(s), and/or unit(s) 1002 may include a program, a subroutine, a portion of a program, a software component or a hardware component capable of performing a stated task or function. As used herein, the module(s), engine(s), and/or unit(s) may be implemented on a hardware component such as a server independently of other modules, or a module can exist with other modules on the same server, or within the same program. The module(s), engine(s), and/or unit(s) 1002 may be implemented on a hardware component such as processor one or more microprocessors, microcomputers, microcontrollers, digital signal processors, central processing units, state machines, logic circuitries, and/or any devices that manipulate signals based on operational instructions. The module(s), engine(s), and/or unit(s) 1002 when executed by the processor(s) 1001 may be configured to perform any of the described functionalities. In an alternate embodiment, the functions of the aforesaid modules may be performed by the processor(s) 1001.

As a further example, the database 1005 may be implemented with integrated hardware and software. The hardware may include a hardware disk controller with programmable search capabilities or a software system running on general-purpose hardware. Examples of databases are but are not limited to, in-memory databases, cloud databases, distributed databases, embedded databases, and the like. The database amongst other things, serves as a repository for storing data processed, received, and generated by one or more of the processors(s) 1001, and the modules/engines/units.

The modules/engines/units 1002 may be implemented with an AI module that may include a plurality of neural network layers. Examples of neural networks include, but are not limited to, a convolutional neural network (CNN), a deep neural network (DNN), a recurrent neural network (RNN). The learning technique is a method for training a predetermined target device using a plurality of learning data to cause, allow, or control the target device to decide or prediction. Examples of the learning techniques include, but are not limited to, a supervised learning, unsupervised learning, a semi-supervised learning, or reinforcement learning. At least one of a plurality of CNN, DNN, RNN models and the like may be implemented to thereby achieve execution of the present subject matter's mechanism through an AI model. A function associated with the AI model may be performed through the non-volatile memory, the volatile memory, and the processor. The processor may include one or a plurality of processors. At this time, one or a plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The one or a plurality of processors control the processing of the input data in accordance with a predefined operating rule or the artificial intelligence (AI) model stored in the non-volatile memory and the volatile memory. The predefined operating rule or artificial intelligence model is provided through training or learning.

In an embodiment, one or more display unit 1004 may include a computer monitor, a touch screen, an output device capable of displaying the graphics, and the like. The display unit 1004 is configured to display visual output in desktops, laptops, and workstations. The display unit 1004 may come in different sizes, resolutions, and types (such as LCD, LED, or OLED).

As a further example, one or more network interface 1006 is configured to provide and establish communication with any electronic device via a public network, private network, or any wireless communication technology.

The figures of the disclosure are provided to illustrate some examples of the invention described. The figures are not to limit the scope of the depicted embodiments or the appended claims. Aspects of the disclosure are described herein with reference to the invention to example embodiments for illustration. It should be understood that specific details, relationships, and method are set forth to provide a full understanding of the example embodiments. One of ordinary skill in the art recognize the example embodiments can be practiced without one or more specific details and/or with other methods.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Aspects of the present disclosure may be implemented as computer program products that comprise articles of manufacture. Such computer program products may include one or more software components including, for example, applications, software objects, methods, data structure, and/or the like. In some embodiments, a software component may be stored on one or more non-transitory computer-readable media, which computer program product may comprise the computer-readable media with software component, comprising computer executable instructions, included thereon. The various control and operational systems described herein may incorporate one or more of such computer program products and/or software components for causing the various conveyors and components thereof to operate in accordance with the functionalities described herein.

A software component may be coded in any of a variety of programming languages. An illustrative programming language may be a lower-level programming language such as an assembly language associated with a particular hardware architecture and/or operating system platform/system. Other example of programming languages included, but are not limited to, a macro language, a shell or command language, a job control language, a script language, a database query, or search language, and/or report writing language. In one or more example embodiments, a software component comprising instructions in one of the foregoing examples of programming languages may be executed directly by an operating system or other software component without having to be first transformed into another form. A software component may be stored as a file or other data storage methods. Software components of a similar type or functionally related may be stored together such as, for example, in a particular directory, folder, or repository. Software components may be static (e.g., pre-established, or fixed) or dynamic (e.g., created or modified at the time of execution).

While this specification contains many specific implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable sub combination. Moreover, although features may be described above as acting in certain combinations and even initially claimed as such, one or more features from a claimed combination can in some cases be excised from the combination, and the claimed combination may be directed to a sub combination or variation of a sub combination.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

It is to be understood that the disclosure is not to be limited to the specific embodiments disclosed, and that modifications and other embodiments are intended to be included within the scope of the appended claims. Although specific terms are employed herein, they are used in a generic and descriptive sense only and not for purposes of limitation, unless described otherwise.

A processor may include one or more general purpose processors (e.g., INTEL® or Advanced Micro Devices® (AMD) microprocessors) and/or one or more special purpose processors (e.g., digital signal processors or Xilinx® System on Chip (SOC) Field Programmable Gate Array (FPGA) processor), MIPS/ARM-class processor, a microprocessor, a digital signal processor, an application specific integrated circuit, a microcontroller, a state machine, or any type of programmable logic array.

A memory may include, but is no limited to, non-transitory machine-readable storage devices such as hard drives, magnetic tape, floppy diskettes, optical disks, Compact Disc Read-Only Memories (CD-ROMs), and magneto-optical disks, semiconductor memories, such as ROMs, Random Access Memories (RAMs), Programmable Read-Only Memories (PROMs), Erasable PROMs (EPROMs), Electrically Erasable PROMs (EEPROMs), flash memory, magnetic or optical cards, or other type of media/machine-readable medium suitable for storing electronic instructions.

The terms user, operator may have been used interchangeably throughout the draft and corresponds to an individual working in an industry or directly or indirectly managing operations in the industrial environment.

The terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

Any combination of the above features and functionalities may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set as claimed in claims that issue from this application, in the specific form in which such claims issue, including any subsequent correction.

What is claimed is:

1. A method for investigating alerts in a network for cyber insights (CI), comprising:
operating at least one CI sensor to mirror one or more data packets in a network traffic between a source node and a destination node;
analysing, by the at least one CI sensor, one or more mirrored data packets to detect anomalous data;
identifying, by the at least one CI sensor, data packet information corresponding to the one or more mirrored data packets with the anomalous data, the data packet information includes at least one of an event, a source node, a destination node, mirrored data packet command, a command type, and a communication protocol;
retrieving, by the at least one CI sensor, raw packet data associated with the one or more mirrored data packets with the anomalous data;
sending, by the at least one CI sensor to a central system, an alert message and the raw packet data, wherein the alert message includes the data packet information;
generating, by the central system, a packet capture (Pcap) file based on the alert message and the raw packet data; and
sending the alert message to at least one user device, via a user interface, for identifying intrusion detection (ID) by a user.

2. The method of claim 1, wherein the raw packet data includes parameters and variables of the mirrored data packets along with bytes for analysis by user, for identifying the bytes which triggered the alert message.

3. The method of claim 1, further comprising:
downloading, by the user device, the packet capture (Pcap) file; and
saving the downloaded packet capture (Pcap) file on a local server.

4. The method of claim 3, further comprising:
executing the Pcap file on the local server to perform analysis of specific bytes in the mirrored data packet.

5. The method of claim 1, further comprising:
creating, by the central system, a packet dissection object for each of the alert message corresponding to one or more of the mirrored data packets with the anomalous data.

6. The method of claim 5, wherein the packet dissection object includes at least one of command description, command type, communication protocol, time of event, the source node and the destination node.

7. The method of claim 5, further comprising:
creating a link between the packet dissection object and the mirrored data packets with the anomalous data which triggered the alert message.

8. The method of claim 1, further comprising:
retrieving, by the at least CI sensor, one or more additional data packets associated with the network traffic between the source node and the destination node surrounding the mirrored data packet with the anomalous data; and
creating, by the central system, one or more packet dissection objects associated with the additional data packets.

9. The method of claim 8, further comprising:
filtering, by the user, the one or more packet dissection objects associated with the additional data packets, based on the user selection.

10. The method of claim 8, further comprising:
analysing the one or more packet dissection objects associated with the additional data packets, surrounding the packet dissection object associated with the mirrored data packet with the anomalous data.

11. A system for investigating alerts in a network for cyber insights (CI) comprising:
a central system executing cyber insights (CI);
at least one cyber insight sensors (CI) sensors coupled to the central system in a network, wherein the at least one CI sensors having one or more processors with a memory and is configured to:
mirror one or more data packets in a network traffic between a source node and a destination node;
analyse one or more mirrored data packets to detect anomalous data;
identify data packet information corresponding to the one or more mirrored data packets with the anomalous data, the data packet information includes at least one of an event, a source node, a destination node, mirrored data packet command, a command type, and a communication protocol;
retrieve raw packet data associated with the one or more mirrored data packets with the anomalous data;
send an alert message and the raw packet data, wherein the alert message includes the data packet information;
wherein
the central system is configured to:
generate a packet capture (Pcap) file based on the alert message and the raw packet data; and
send the alert message to at least one user device, via a user interface, for identifying intrusion detection (ID) by a user.

12. The system of claim 11, wherein the at least user device is configured to:
download the packet capture (Pcap) file; and
save the Pcap file on a local server.

13. The system of claim 12, wherein the at least user device is configured to:
execute the Pcap file on the local server to perform analysis of specific bytes in the mirrored data packet.

14. The system of claim 11, wherein the central system is configured to:
create a packet dissection object for the alert message corresponding to each of the mirrored data packet with the anomalous data.

15. The system of claim 14, wherein the packet dissection object comprises at least one of command description, command type, communication protocol, time of event, the source node and the destination node.

16. The system of claim 14, wherein the central system is configured to:
create a link between the packet dissection object and the mirrored data packet with the anomalous data which triggered the alert message.

17. The system of claim 11, wherein the at least one CI sensor is configured to:
retrieve one or more additional data packets associated with the network traffic between the source node and the destination node surrounding the data packet with the anomalous data; and
send the one or more additional data packets to the central system.

18. The system of claim 17, wherein the central system is configured to:
create one or more packet dissection objects associated with the additional data packets.

19. The system of claim 18, wherein the user device is configured to perform analysis of the one or more packet dissection objects associated with the additional data packets, surrounding the packet dissection object associated with the mirrored data packet with the anomalous data.

20. A non-transitory computer-readable storage medium storing program instructions for investigating alerts in a network for cyber insights (CI), the instructions, when executed by at least one CI sensor and a central system, perform the steps of:
mirroring one or more data packets in a network traffic between a source node and a destination node;
analysing one or more mirrored data packets to detect anomalous data;
identifying data packet information corresponding to the one or more mirrored data packets with the anomalous data, the information includes at least one of an event, a source node, a destination node, mirrored data packet command, a command type, and a communication protocol;
retrieving raw packet data associated with the one or more mirrored data packets with the anomalous data;
sending an alert message and the raw packet data, wherein the alert message includes the data packet information;
generating a packet capture (Pcap) file based on the alert message and the raw packet data; and
sending the alert message to at least one user device, via a user interface, for identifying intrusion detection (ID).
